(19) United States
(12) Patent Application Publication
(10) Pub. No.: US 2026/0050162 A1
(43) Pub. Date: Feb. 19, 2026

(54) STEREOSCOPIC DISPLAY APPARATUS

(71) Applicant: AUO Corporation, Hsinchu City (TW)

(72) Inventors: Guang Fu Wang, Hsinchu City (TW); Yu-Ping Kuo, Hsinchu City (TW); Yin-Ting Lee, Hsinchu City (TW); Wei-Ting Hsu, Hsinchu City (TW); Tung Chun Chiang, Hsinchu City (TW); Ko Chen Chang, Hsinchu City (TW); Ya-Ting Chen, Hsinchu City (TW); Sheng-Wen Cheng, Hsinchu City (TW); Chih-Ming Tsai, Hsinchu City (TW)

(73) Assignee: AUO Corporation, Hsinchu City (TW)

(21) Appl. No.: 19/238,556

(22) Filed: Jun. 16, 2025

Related U.S. Application Data
(60) Provisional application No. 63/683,722, filed on Aug. 16, 2024.

(30) Foreign Application Priority Data
Feb. 10, 2025 (TW) 114104919

(51) Int. Cl. G02B 27/01

(52) U.S. Cl. CPC G02B 27/0149; G02B 2027/0161; G02B 2027/0169

(57) ABSTRACT

A stereoscopic display apparatus includes a first display element, a second display element and a first concealing element. The second display element has a first area and a second area. The first area of the second display element overlaps the first display element. The second area of the second display element is located outside an area of the first display element. The first concealing element is located between the first display element and the second display element. The first concealing element has a first light shielding portion. A solid portion of the first light shielding portion overlaps the second area of the second display element. A main opening of the first light shielding portion is located above the first display element.

### CROSS-REFERENCE TO RELATED APPLICATION

This application claims the priority benefit of U.S. provisional application Ser. No. 63/683,722, filed on Aug. 16, 2024 and Taiwan application serial no. 114104919, filed on Feb. 10, 2025. The entirety of each of the above-mentioned patent applications is hereby incorporated by reference herein and made a part of this specification.

### BACKGROUND

### Technical Field

The disclosure relates to a display apparatus, and in particular relates to a stereoscopic display apparatus.

### Description of Related Art

In recent years, with the advancement of display technology, users have increasingly demanded higher display quality (e.g., image resolution, color saturation, etc.). In addition to high image resolution and color saturation, in certain applications, users also desire displays capable of presenting stereoscopic images.

Current stereoscopic image display technologies can generally be categorized into glasses-type stereoscopic displays that require users to wear specialized glasses, and naked eyes-type (namely auto-stereoscopic) stereoscopic displays that can be viewed directly with naked eyes. Conventional auto-stereoscopic displays present issues where the displayed images may cause dizziness for users. Consequently, alternative auto-stereoscopic display technologies have been proposed, such as multi-layer displays. A multi-layer display includes a first display panel disposed at the rear and a transparent second display panel disposed at the front, in which an actual distance exists between the first display panel and the transparent second display panel. As multi-layer displays possess true depth properties, users do not encounter issues of dizziness resulting from the images. However, since the second display panel of a multi-layer display is disposed in front of the first display panel, the second display panel is susceptible to structural integrity deficiencies.

### SUMMARY

A stereoscopic display apparatus with sufficient strength is provided in the disclosure.

The stereoscopic display apparatus of the disclosure comprises a first display element, a second display element, a first concealing element and a photosensitive element. The second display element is spaced a distance from the first display element. The second display element has a first area and a second area. The first area of the second display element overlaps the first display element. The second area of the second display element is located outside an area of the first display element. The first concealing element is located between the first display element and the second display element, and is adjacent to the second display element. The first concealing element has a first light shielding portion. A solid portion of the first light shielding portion overlaps the second area of the second display element. A main opening of the first light shielding portion is located above the first display element. The photosensitive element is located outside the area of the first display element and is offset from the solid portion of the first light shielding portion of the first concealing element.

### BRIEF DESCRIPTION OF THE DRAWINGS

FIG. 1 is a cross-sectional schematic diagram of a stereoscopic display apparatus of an embodiment of the disclosure.

FIG. 2 is a three-dimensional exploded schematic diagram of a stereoscopic display apparatus of an embodiment of the disclosure.

FIG. 3 is a three-dimensional schematic diagram of a stereoscopic display apparatus of an embodiment of the disclosure.

FIG. 4 is a partial three-dimensional schematic diagram of a stereoscopic display apparatus of an embodiment of the disclosure.

FIG. 5 is a flowchart schematic diagram of an operational mode of a stereoscopic display apparatus of an embodiment of the disclosure.

FIG. 6 is a flowchart schematic diagram of another operational mode of a stereoscopic display apparatus of an embodiment of the disclosure.

FIG. 7 is a cross-sectional schematic diagram of a stereoscopic display apparatus of another embodiment of the disclosure.

FIG. 8 is a cross-sectional schematic diagram of a stereoscopic display apparatus of yet another embodiment of the disclosure.

### DETAILED DESCRIPTION OF DISCLOSED EMBODIMENTS

References of the exemplary embodiments of the disclosure are to be made in detail. Examples of the exemplary embodiments are illustrated in the drawings. If applicable, the same reference numerals in the drawings and the descriptions indicate the same or similar parts.

It should be understood that when an element such as a layer, a film, an area, or a substrate is indicated to be “on” another element or “connected to” another element, it may be directly on another element or connected to another element, or an element in the middle may exist. In contrast, when an element is indicated to be “directly on another element” or “directly connected to” another element, an element in the middle does not exist. As used herein, “to connect” may indicate to physically and/or electrically connect. Furthermore, “to electrically connect” or “to couple” may also be used when other elements exist between two elements.

The usages of “approximately”, “similar to”, or “substantially” indicated throughout the specification include the indicated value and an average value having an acceptable deviation range, which is a certain value confirmed by people skilled in the art, and is a certain amount considered the discussed measurement and measurement-related deviation (that is, the limitation of measurement system). For example, “approximately” may indicate to be within one or more standard deviations of the indicated value, or being within ±30%, ±20%, ±10%, ±5%. Furthermore, the usages of “approximately”, “similar to”, or “substantially” indicated throughout the specification may refer to a more acceptable deviation scope or standard deviation depending on optical properties, etching properties, or other properties, and all properties may not be applied with one standard deviation.

Unless otherwise defined, all terms (including technical and scientific terms) used herein have the same meaning as that commonly understood by one of ordinary skill in the art to which this disclosure belongs. It should be further understood that terms such as those defined in commonly used dictionaries should be construed as having meanings consistent with their meanings in the context of the related art and the disclosure, and are not to be construed as idealized or excessive formal meaning, unless expressly defined as such herein.

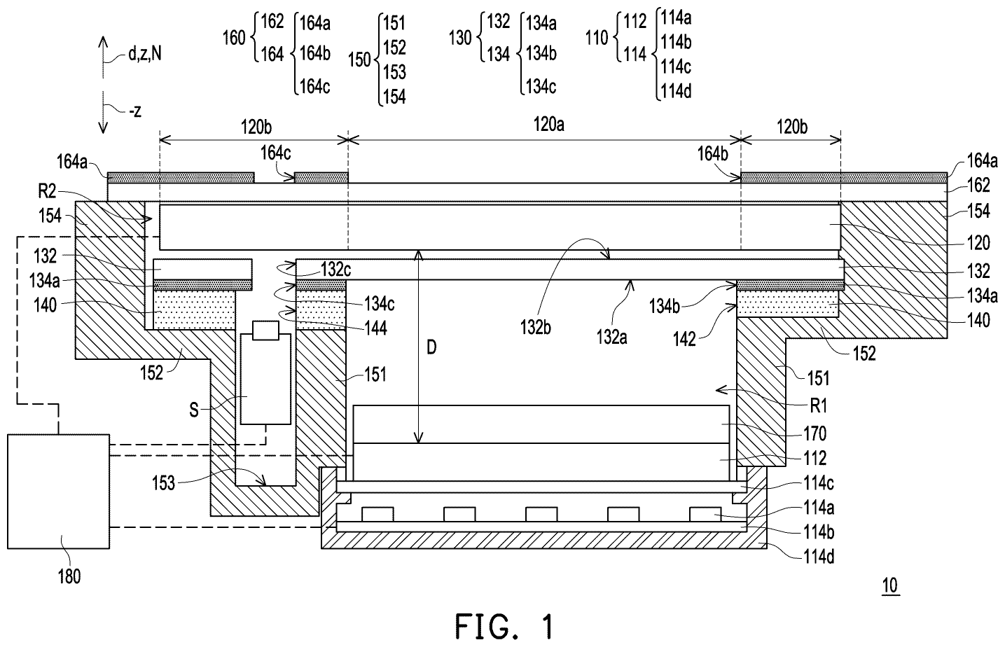

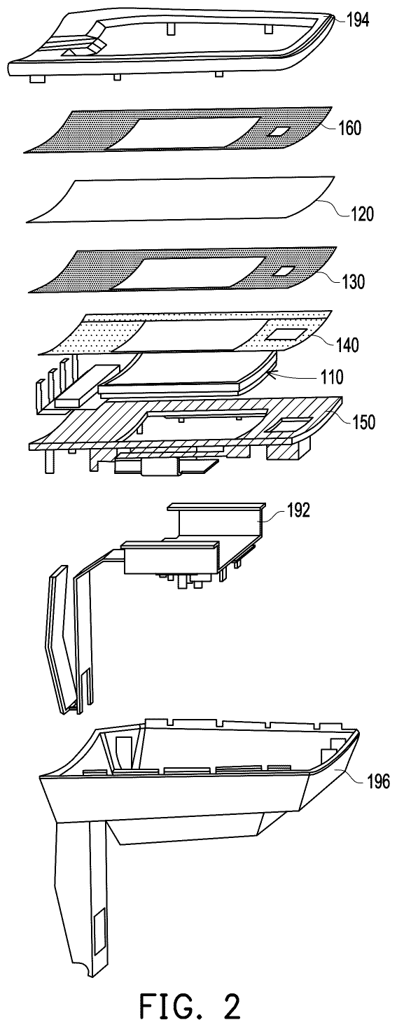

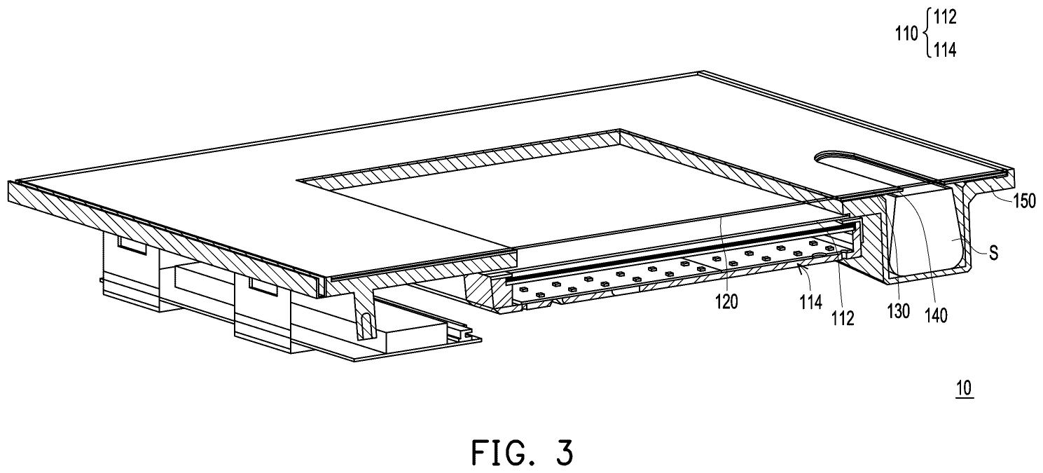

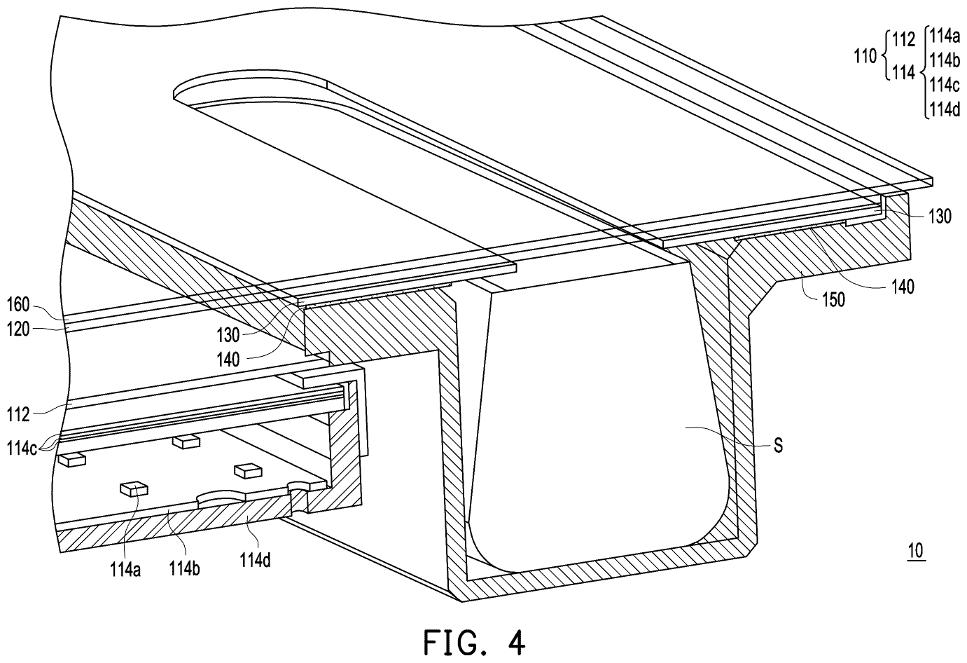

FIG. 1 is a cross-sectional schematic diagram of a stereoscopic display apparatus of an embodiment of the disclosure. FIG. 2 is a three-dimensional exploded schematic diagram of a stereoscopic display apparatus of an embodiment of the disclosure. FIG. 3 is a three-dimensional schematic diagram of a stereoscopic display apparatus of an embodiment of the disclosure. FIG. 4 is a partial three-dimensional schematic diagram of a stereoscopic display apparatus of an embodiment of the disclosure. FIG. 2 depicts the front appearance member 194 and the rear appearance member 196, while FIG. 1, FIG. 3 and FIG. 4 omit the front appearance member 194 and the rear appearance member 196 of FIG. 2. In addition, FIG. 3 omits the second concealing element 160 of FIG. 1, FIG. 2 and FIG. 4.

Referring to FIG. 1, FIG. 2, FIG. 3 and FIG. 4, the stereoscopic display apparatus 10 includes a first display element 110 and a second display element 120. The first display element 110 is spaced a distance D from the second display element 120 in a direction d parallel to the line of sight of the user. The second display element 120 is a transparent display. In some embodiments, the transmittance of the second display element 120 may be greater than or equal to 50%. A first image displayed by the first display element 110 can be received by the user's eyes through the second display element 120. That is, the eyes of the user can simultaneously receive the first image displayed by the first display element 110 and a second image displayed by the second display element 120. Since the first display element 110 is spaced an actual distance D from the second display element 120 in a direction d parallel to the line of sight of the user, the coordination between the first image displayed through the first display element 110 and the second image displayed through the second display element 120 provides an actual depth-of-field image. After the actual depth-of-field image is received by the human eye, the brain can perceive a stereoscopic image. In some embodiments, the resolution of the second display element 120 is, for example, in the range of 60 ppi to 200 ppi, the distance D is, for example, in the range of 4.5 mm to 7.5 mm, and the resolution of the first display element 110 is, for example, in the range of 100 ppi to 300 ppi. In some embodiments, preferably, the resolution of the second display element 120 is 85 ppi, the distance D is about 6 mm, and the resolution of the first display element 110 is 167 ppi or 210 ppi, but the disclosure is not limited thereto.

In some embodiments, the second display element 120 is, for example, a transparent light-emitting diode display panel. The transparent light-emitting diode display panel may include a driving backplane having multiple penetration areas and pixel areas, multiple light-emitting diodes disposed in the pixel areas and electrically connected to the driving backplane, and a molding layer covering the light-emitting diodes. However, the disclosure is not limited thereto, and in other embodiments, the second display element 120 may also be other types of transparent displays.

In some embodiments, the first display element 110 may include, for example, a liquid crystal display panel 112 and a backlight module 114 disposed behind the liquid crystal display panel 112. In some embodiments, the backlight module 114 may selectively have a local dimming function. In some embodiments, the backlight module 114 may include a circuit board 114b, multiple light-emitting elements 114a electrically connected to the circuit board 114b, at least one optical film 114c disposed above the light-emitting elements 114a, and a back frame 114d for accommodating the circuit board 114b, the light-emitting elements 114a and the at least one optical film 114c. However, the disclosure is not limited thereto, and in other embodiments, the first display element 110 may also be other types of displays.

In some embodiments, in order to cooperate with the application of the stereoscopic display apparatus 10 (e.g., used as an electronic dashboard in front of a driver's seat), the first display element 110 and/or may be selectively curved to have a radius of curvature. For example, in some embodiments, the radius of curvature of the second display element 120 is, for example, 3000 mm, and the first display element 110 may not be curved and may be a plane. In some other embodiments, the first display element 110 and the second display element 120 may both be curved and have a radius of curvature.

The stereoscopic display apparatus 10 further includes a first concealing element 130 located between the first display element 110 and the second display element 120. The first concealing element 130 is adjacent to the second display element 120. The first concealing element 130 is closer to the second display element 120 and farther from the first display element 110. The second display element 120 has a first area 120a and a second area 120b. The first area 120a of the second display element 120 overlaps the first display element 110. The second area 120b of the second display element 120 is located outside the area of the first display element 110. The first concealing element 130 has a first light shielding portion 134. A solid portion 134a of the first light shielding portion 134 overlaps the second area 120b of the second display element 120. A main opening 134b of the first light shielding portion 134 is located above the first display element 110. The first concealing element 130 can increase the strength of the second display element 120 and provide concealing and supporting functions.

For example, in some embodiments, the first concealing element 130 may include a first transparent substrate 132, in which the first light shielding portion 134 is disposed on the first transparent substrate 132. In some embodiments, the first light shielding portion 134 may be selectively disposed on a surface 132a of the first transparent substrate 132 facing the first display element 110. However, the disclosure is not limited thereto. In other embodiments, the first light shielding portion 134 may also be selectively disposed on a surface 132b of the first transparent substrate 132 facing away from the first display element 110. In some embodiments, the first light shielding portion 134 is, for example, an ink pattern layer, but the disclosure is not limited thereto.

The stereoscopic display apparatus 10 further includes a photosensitive element S, which is located outside the area of the first display element 110 and is offset from the solid portion 134a of the first light shielding portion 134 of the first concealing element 130. For example, in some embodiments, the first concealing element 130 may be selectively located between the photosensitive element S and the second display element 120. That is, in some embodiments, the photosensitive element S may be selectively disposed behind the first concealing element 130. In some embodiments, the first light shielding portion 134 of the first concealing element 130 further has an auxiliary opening 134c, and the first transparent substrate 132 of the first concealing element 130 has a through hole 132c. The auxiliary opening 134c and the through hole 132c can substantially coincide, and the auxiliary opening 134c and the through hole 132c are located above the photosensitive element S. The sensing light from the outside can be transmitted to the photosensitive element S more effectively through the auxiliary opening 134c and the through hole 132c, thereby obtaining an image with better quality. In some embodiments, the photosensitive element S is, for example, an image capturing element capable of sensing visible light spectrum and/or infrared light spectrum, but the disclosure is not limited thereto.

In some embodiments, the stereoscopic display apparatus 10 further includes a supporting structure 150. The supporting structure 150 is configured to support the first display element 110 and the second display element 120, and to maintain a distance D between the first display element 110 and the second display element 120.

Specifically, in some embodiments, the supporting structure 150 includes a first sidewall 151 and a carrier 152. The first sidewall 151 defines a first accommodating space R1, and at least a portion of the first display element 110 is disposed in the first accommodating space R1. The carrier 152 is connected to an end of the first sidewall 151 away from the first display element 110, and extends out of the first accommodating space R1. The first concealing element 130 is disposed on the carrier 152, and the first light shielding portion 134 of the first concealing element 130 shields the carrier 152 and the first sidewall 151. In some embodiments, the supporting structure 150 may further selectively include a groove 153. The first sidewall 151 is located between at least a portion of the first display element 110 and the groove 153, and the photosensitive element S can be selectively disposed in the groove 153, but the disclosure is not limited thereto.

In some embodiments, the stereoscopic display apparatus 10 further includes an adhesive element 140 disposed on the carrier 152 of the supporting structure 150 and connecting the first concealing element 130 and the carrier 152 of the supporting structure 150. In some embodiments, the adhesive element 140 may have a first through hole 142 and a second through hole 144, which are respectively located above the first display element 110 and the photosensitive element S. In some embodiments, the adhesive element 140 may also have a buffering function. For example, in some embodiments, the adhesive element 140 may be a foam material, but the disclosure is not limited thereto. In some embodiments, the adhesive element 140 has not only the adhesive and buffering functions but also a dustproof function, which can prevent dust from entering the first accommodating space R1 and accumulating on the first display element 110.

In some embodiments, the supporting structure 150 further includes a second sidewall 154 connected to the carrier 152. The first sidewall 151 and the second sidewall 154 extend in opposite directions z and −z, and are respectively located at two opposite sides of the carrier 152. The carrier 152 and the second sidewall 154 define a second accommodating space R2. The second display element 120 and the first concealing element 130 are disposed in the second accommodating space R2.

In some embodiments, the stereoscopic display apparatus 10 further includes a second concealing element 160 disposed on the second sidewall 154 of the supporting structure 150. The second display element 120 is located between the second concealing element 160 and the first concealing element 130. The second concealing element 160 has a second light shielding portion 164. A solid portion 164a of the second light shielding portion 164 shields the second area 120b of the second display element 120 and the second sidewall 154 of the supporting structure 150. The second light shielding portion 164 has a main opening 164b located above the first display element 110. In some embodiments, the second light shielding portion 164 of the second concealing element 160 further has an auxiliary opening 164c located above the photosensitive element S and the groove 153 of the supporting structure 150. The second concealing element 160 can shield the second area 120b (i.e., the non-display area) of the second display element 120 to reduce the haze effect of the second display element 120. In addition, the second concealing element 160 can also increase the strength of the second display element 120. In some embodiments, the second concealing element 160 may include a second transparent substrate 162, in which the second light shielding portion 164 is disposed on the second transparent substrate 162. The sensing light from the outside can be transmitted to the photosensitive element S through the auxiliary opening 164c of the second light shielding portion 164, the second transparent substrate 162, the second display element 120, the through hole 132c and the auxiliary opening 134c of the first concealing element 130, and the second through hole 144 of the adhesive element 140.

In some embodiments, the stereoscopic display apparatus 10 further includes an anti-reflection and anti-glare film 170 disposed on the first display element 110 and located in the first accommodating space R1 of the supporting structure 150. The anti-reflection and anti-glare film 170 is disposed between the first display element 110 and the second display element 120 to destroy the interference between the first display element 110 and the second display element 120, thereby improving the problem of Moire. In some embodiments, the haze of the anti-reflection and anti-glare film 170 may be in the range of 60% to 80%. In some embodiments, preferably, the haze of the anti-reflection and anti-glare film 170 is within the range of 74%±8%, but the disclosure is not limited thereto.

In some embodiments, the stereoscopic display apparatus 10 may further include a support steel frame 192 (shown in FIG. 2), a front appearance member 194, and a rear appearance member 196. The support steel frame 192 is configured to secure the supporting structure 150. The front appearance member 194 and the rear appearance member 196 are configured to protect the components therein (e.g., the second concealing element 160, the second display element 120, the first concealing element 130, the first display element 110, etc.) and also provide an aesthetic effect.

Referring to FIG. 1, in some embodiments, the stereoscopic display apparatus 10 further includes a processing element 180 electrically connected to the first display element 110, the second display element 120 and the photosensitive element S. In some embodiments, the processing element 180 can determine the display screen of at least one of the first display element 110 and the second display element 120 according to the signal provided by the photosensitive element S.

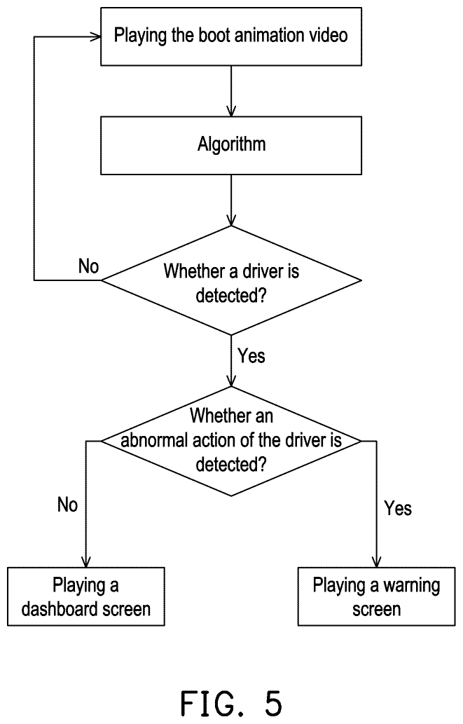

FIG. 5 is a flowchart schematic diagram of an operational mode of a stereoscopic display apparatus of an embodiment of the disclosure. Referring to FIG. 1 and FIG. 5, for example, in some embodiments, the photosensitive element S of the stereoscopic display apparatus 10 can be configured to detect driving behavior, thereby enabling the stereoscopic display apparatus 10 to respond accordingly. Initially, the processing element 180 enables the first display element 110 and/or the second display element 120 to play a boot animation video. Subsequently, as the system boots up, the processing element 180 initiates a first stage detection algorithm, using the photosensitive element S to monitor a human face (or a driver). If a human face (or a driver) is detected, the processing element 180 enables the first display element 110 and/or the second display element 120 to enter an unlocking screen and enter a dashboard screen, and the processing element 180 initiates a second stage detection algorithm. If no human face (or driver) is detected, the boot animation video will continue to play. In the second stage detection algorithm, if abnormal movement of the human face (or the driver) is detected (e.g., dangerous driving behaviors such as holding a mobile phone, turning the head, and dozing off), the processing element 180 enables the first display element 110 and/or the second display element 120 to play a warning screen, which may be accompanied by a warning sound. In the second stage detection of the algorithm, if no abnormal movement of the human face (or the driver) is detected, the processing element 180 enables the first display element 110 and/or the second display element 120 to keep playing the dashboard screen.

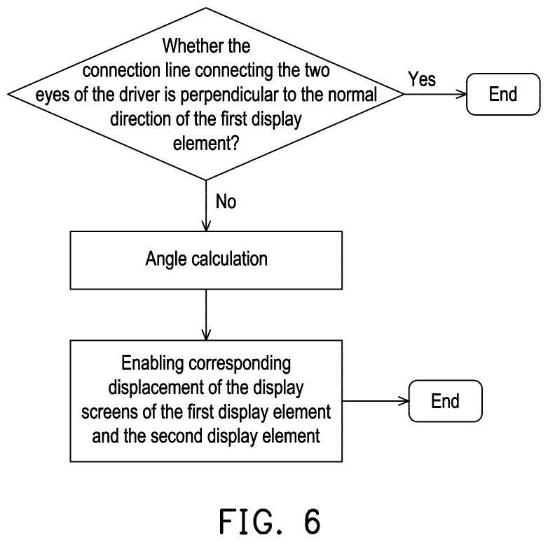

FIG. 6 is a flowchart schematic diagram of another operational mode of a stereoscopic display apparatus of an embodiment of the disclosure. Referring to FIG. 1 and FIG. 6, for example, in some embodiments, the photosensitive element S of the stereoscopic display apparatus 10 can be configured to detect the driver angle, thereby enabling the stereoscopic display apparatus 10 to respond accordingly. The driver angle refers to the angle of the eyes of the drivers relative to the stereoscopic display apparatus 10. Referring to FIG. 1 and FIG. 6, after entering the dashboard screen, the processing element 180 may initiate detecting the driver angle. If it is detected that the connection line connecting the two eyes of the driver is not perpendicular to the normal direction N of the first display element 110, the processing element 180 can perform an angle calculation according to a human factor data lookup table to enable a corresponding displacement of the display screen of the second display element 120 in front and the display screen of the first display element 110 at the rear, thereby optimizing the stereoscopic display effect.

In some embodiments, the possible positions of the eyes of the driver can be divided into i regions (e.g., if i=3, the possible positions of the eyes of the driver are divided into the left region, the middle region, and the right region; if i=9, the possible positions of the eyes of the driver are divided into nine-square grid regions . . . ), and the optimal positions to which the display screens of the front and rear displays (i.e., the second display screen of the second display element 120 and the first display screen of the first display element 110) need to be moved are recorded in advance for the q^{th} region, in which q is a positive integer greater than or equal to 1 and less than or equal to i. If the eyes of the driver are detected to be in the abnormal q^{th} region, the images of the front and rear displays can be displaced accordingly according to the previously recorded data to optimize the stereoscopic display effect.

It is to be noted that the following embodiments use the reference numerals and a part of the contents of the above embodiments, and the same reference numerals are used to denote the same or similar elements, and the description of the same technical contents is omitted. For the description of the omitted part, reference may be made to the above embodiments, and details are not described in the following embodiments.

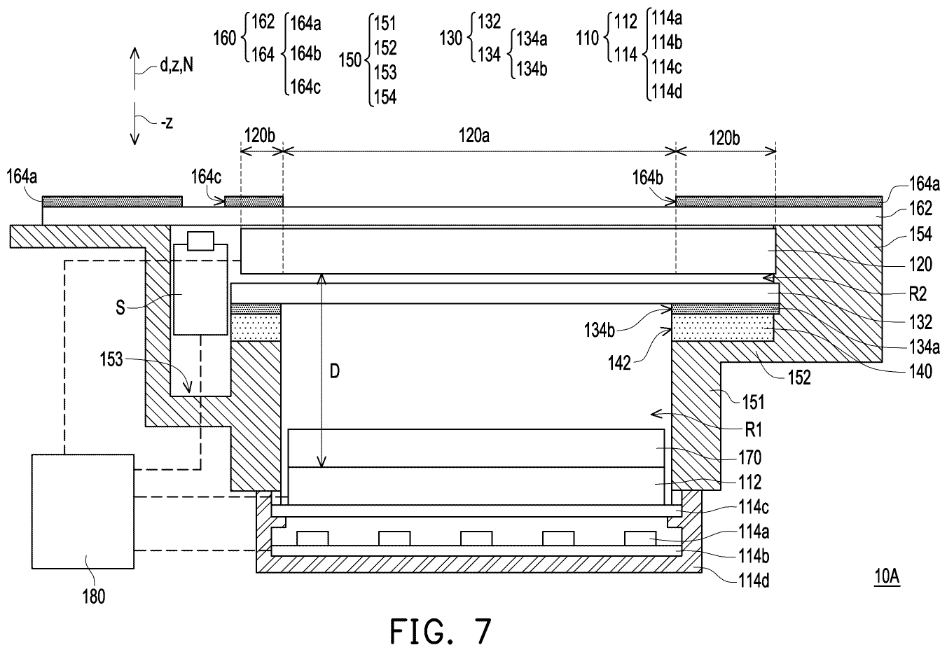

FIG. 7 is a cross-sectional schematic diagram of a stereoscopic display apparatus of another embodiment of the disclosure. The stereoscopic display apparatus 10A of the present embodiment is similar to the aforementioned stereoscopic display apparatus 10, and the difference between the two is that the position of the photosensitive element S differs between the two apparatuses. Referring to FIG. 7, specifically, in this embodiment, the photosensitive element S is not disposed below the second display element 120 and the first concealing element 130. The photosensitive element S is located on the side of the second display element 120 and the side of the first concealing element 130 and below the first concealing element 130.

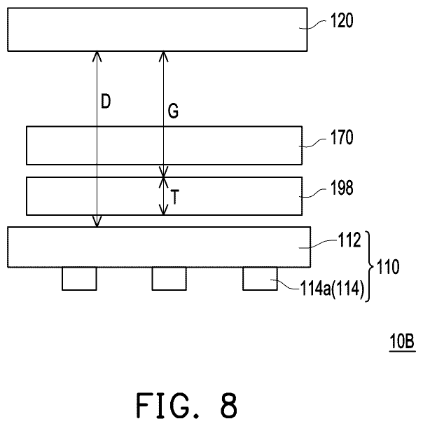

FIG. 8 is a cross-sectional schematic diagram of a stereoscopic display apparatus of yet another embodiment of the disclosure. The stereoscopic display apparatus 10B of the present embodiment is similar to the aforementioned stereoscopic display apparatus 10, and the difference between the two is that the distance D between the first display element 110 and the second display element 120 differs between the two apparatuses. Referring to FIG. 1, the aforementioned stereoscopic display apparatus 10 is applied, for example, in the field of automotive display, and the distance D (e.g., about 6 mm) between the first display element 110 and the second display element 120 is slightly greater. Referring to FIG. 8, the stereoscopic display apparatus 10B of the present embodiment is applied, for example, in the field of wearable display (e.g., watches), and the distance D between the first display element 110 and the second display element 120 is, for example, less than 2.5 mm. Referring to FIG. 8, in addition, in this embodiment, the stereoscopic display apparatus 10B may further include a transparent element 198 disposed between the anti-reflection and anti-glare film 170 and the first display element 110.

A gap G is provided between the second display element 120 and the transparent element 198. The transparent element 198 has a thickness T. Table 1 below lists the parameters of various components of various embodiments of the stereoscopic display apparatus 10B and the test results of Moire and text clarity. As can be seen from Table 1 below, in some embodiments, the resolution of the second display element 120 is in the range of 60 ppi to 200 ppi, the gap G is in the range of 0 mm to 2 mm, the haze of the anti-reflection and anti-glare film 170 is in the range of 60% to 80%, the thickness T of the transparent element 198 is in the range of 0 mm to 1.25 mm, and the resolution of the first display element 110 is in the range of 100 ppi to 450 ppi. The stereoscopic display apparatus 10B exhibits good optical performance and visual aesthetics.

TABLE 1

| | Embodiment 1 | Embodiment 2 | Embodiment 3 | Embodiment 4 |
|---|---|---|---|---|
| The resolution | 163 | 163 | 163 | 163 |
| of the second | | | | |
| display element | | | | |
| 120 (ppi) | | | | |
| Gap G (mm) | 1.5 | 0.25, 0.5 | 0.25, 0.5 | 0.25, 0.5 |
| The haze of the | 74% ± 8% | 74% ± 8% | 74% ± 8% | 74% ± 8% |
| anti-reflection | | | | |
| and anti-glare | | | | |
| film 170 | | | | |
| The thickness T | 0.5 to 0.7 | 0.5 | 0.25 | None |
| of the | | | | |
| transparent | | | | |
| element 198 | | | | |
| (mm) | | | | |
| The resolution | 167 | 167 | 209 | 300 |
| of the first | | | | |
| display element | | | | |
| 110 (ppi) | | | | |
| Moire test result | OK | OK | OK | OK |
| Clear text test | — | OK | OK | OK |
| result | | | | |

What is claimed is:

1. A stereoscopic display apparatus, comprising:
a first display element;
a second display element, spaced a distance from the first display element, wherein the second display element has a first area and a second area, the first area of the second display element overlaps the first display element, and the second area of the second display element is located outside an area of the first display element
a first concealing element, located between the first display element and the second display element, and adjacent to the second display element, wherein the first concealing element has a first light shielding portion, a solid portion of the first light shielding portion overlaps the second area of the second display element, and a main opening of the first light shielding portion is located above the first display element; and
a photosensitive element, located outside the area of the first display element and offset from the solid portion of the first light shielding portion of the first concealing element.

2. The stereoscopic display apparatus according to claim 1, further comprising:
a supporting structure, comprising:
a first sidewall, defining a first accommodating space, wherein at least a portion of the first display element is disposed in the first accommodating space;
a carrier, connected to an end of the first sidewall away from the first display element and extending out of the first accommodating space, wherein the first concealing element is disposed on the carrier, and the first light shielding portion of the first concealing element shields the carrier and the first sidewall; and
a groove, wherein the first sidewall is located between the at least a portion of the first display element and the groove, and the photosensitive element is disposed in the groove.

3. The stereoscopic display apparatus according to claim 2, further comprising:
an adhesive element, disposed on the carrier of the supporting structure and connecting the first concealing element and the carrier of the supporting structure.

4. The stereoscopic display apparatus according to claim 3, wherein the adhesive element has a first through hole and a second through hole, which are respectively located above the first display element and the photosensitive element.

5. The stereoscopic display apparatus according to claim 2, wherein the supporting structure further comprises:
a second sidewall, connected to the carrier, wherein the first sidewall and the second sidewall extend in opposite directions and are respectively located at opposite sides of the carrier, the carrier and the second sidewall define a second accommodating space, and the second display element and the first concealing element are disposed in the second accommodating space.

6. The stereoscopic display apparatus according to claim 5, further comprising:
a second concealing element, disposed on the second sidewall of the supporting structure, wherein the second display element is located between the second concealing element and the first concealing element, the second concealing element has a second light shielding portion, a solid portion of the second light shielding portion shields the second area of the second display element and the second sidewall of the supporting structure, and a main opening of the second light shielding portion is located above the first display element.

7. The stereoscopic display apparatus according to claim 6, wherein the second light shielding portion of the second concealing element further has an auxiliary opening located above the photosensitive element and the groove of the supporting structure.

8. The stereoscopic display apparatus according to claim 2, further comprising:
an anti-reflection and anti-glare film, disposed on the first display element and located in the first accommodating space of the supporting structure.

9. The stereoscopic display apparatus according to claim 1, wherein the first concealing element is located between the photosensitive element and the second display element.

10. The stereoscopic display apparatus according to claim 1, further comprising:
a processing element, electrically connected to the first display element, the second display element and the photosensitive element, wherein the processing element determines a display screen of at least one of the first display element and the second display element according to a signal provided by the photosensitive element.

11. A stereoscopic display apparatus, comprising:
a first display element;
a second display element, spaced a distance from the first display element, wherein the second display element has a first area and a second area, the first area of the second display element overlaps the first display element, and the second area of the second display element is located outside an area of the first display element a first concealing element, located between the first display element and the second display element, and adjacent to the second display element, wherein the first concealing element has a first light shielding portion, a solid portion of the first light shielding portion overlaps the second area of the second display element, and a main opening of the first light shielding portion is located above the first display element; and
a supporting structure, comprising:
a first sidewall, defining a first accommodating space, wherein at least a portion of the first display element is disposed in the first accommodating space;
a carrier, connected to an end of the first sidewall away from the first display element and extending out of the first accommodating space, wherein the first concealing element is disposed on the carrier, and the first light shielding portion of the first concealing element shields the carrier and the first sidewall; and
a groove, wherein the first sidewall is located between the at least a portion of the first display element and the groove.

12. The stereoscopic display apparatus according to claim 11, further comprising:
an adhesive element, disposed on the carrier of the supporting structure and connecting the first concealing element and the carrier of the supporting structure.

13. The stereoscopic display apparatus according to claim 12, wherein the adhesive element has a first through hole and a second through hole, which are located above the first display element.

14. The stereoscopic display apparatus according to claim 11, wherein the supporting structure further comprises:
a second sidewall, connected to the carrier, wherein the first sidewall and the second sidewall extend in opposite directions and are respectively located at opposite sides of the carrier, the carrier and the second sidewall define a second accommodating space, and the second display element and the first concealing element are disposed in the second accommodating space.

15. The stereoscopic display apparatus according to claim 14, further comprising:
a second concealing element, disposed on the second sidewall of the supporting structure, wherein the second display element is located between the second concealing element and the first concealing element, the second concealing element has a second light shielding portion, a solid portion of the second light shielding portion shields the second area of the second display element and the second sidewall of the supporting structure, and a main opening of the second light shielding portion is located above the first display element.
